(19) United States
(12) Patent Application Publication
(10) Pub. No.: US 2013/0179722 A1
(43) Pub. Date: Jul. 11, 2013

(54) RING TOPOLOGY FOR COMPUTE DEVICES

(71) Applicants: Glen Smith, Charlottesville, VA (US); Harald Gruber, Augsburg (DE); Peter Missel, Augsburg (DE)

(72) Inventors: Glen Smith, Charlottesville, VA (US); Harald Gruber, Augsburg (DE); Peter Missel, Augsburg (DE)

(21) Appl. No.: 13/345,071

(22) Filed: Jan. 6, 2012

(51) Int. Cl. G06F 13/36; G06F 11/07

(52) U.S. Cl. 714/4.5; 710/314; 714/E11.021

(57) ABSTRACT

Devices, systems and methods for providing a ring topology for physically connecting compute devices having PCIe bridges are disclosed. Each device, having an internal PCIe bus or other similar standard that natively support a tree structure, is connected in a ring to neighboring compute devices. Two physical links connecting each device to the ring are provided, enabling each device to communicate with all of the other devices on the ring, without requiring a server or main host to enumerate or control the flow of information between devices. If a failure occurs in the physical connection at any single point in the ring, there is still an alternate path to communicate with every device. Methods for performing data transfer between PCIe compute devices connected to the ring are also disclosed.

### BACKGROUND OF THE INVENTION

1. Field of the Invention

The field of the invention relates to control systems generally, and more particularly to certain new and useful advances in network topologies connecting multiple devices within control systems for industrial applications, of which the following is a specification.

2. Description of Related Art

At a high level, controller devices are essentially specialized computers that contain most of the components found in a personal computer (hereinafter PC) today, including central processing units (hereinafter CPUs), memory, disk drives, and various input and output (hereinafter I/O) connections. Like computers, controller devices can be linked together in a network in order to communicate information and transfer data back and forth quickly and efficiently.

Industrial control systems today require highly reliable, fail-safe communications. The key to the performance of a distributed system with multiple controller devices lies in the network structure or topology. The network structure must allow the various computing, memory, and I/O elements within the design to exchange data efficiently, and at high bit rates with reliability in the event of a failure.

PCI™ (hereinafter PCI) and its successor PCI Express® (hereinafter PCIe) are serial bus standards that provide electrical, physical and logical interconnections for peripheral components of microprocessor-based systems. The native topology of connections supported by PCIe emulates the tree structure of its predecessor PCI. The native PCI tree topology allows only one master central processing unit (hereinafter CPU) in the system. This master CPU is known as a root complex. Other CPUs and similar compute devices can be connected to the PCI tree as a leaf node to the root complex. If the primary root complex fails, the CPU connected through the non-transparent bridge can take over system control and become the new root complex.

Tree structures have some drawbacks for the needs of modern control systems that connect multiple controller devices in a network. For example, in the standard PCIe tree, all devices must be initialized by a common root complex in a process referred to as PCIe enumeration. The root complex must be aware of all PCIe devices in the network in order for the enumeration process and future communication to be successful. This limits the known topologies of PCIe devices to tree or star topologies and prevents the use of daisy-chained or ring topologies.

Thus, there is a need for devices, systems and methods that take advantage of the high-speed connection capabilities of the PCIe standard without the drawbacks and constraints of known network configurations for PCIe devices.

### BRIEF SUMMARY OF THE INVENTION

The apparatuses, systems and methods of the subject invention are directed to devices that are connected in a ring topology. Each of the devices is capable of high-speed serial communication, and utilizes a communication standard, such as PCIe, in order to transfer and receive data between devices. Each device has multiple ports that are used to connect to neighboring devices. There are two physical links connecting each device, which provide two paths for peer-to-peer communication with all of the other devices on the ring. The ring topology provides for redundant communication paths and ease of expansion not possible with PCIe or similar standards having tree or star topologies. As a result, if a failure occurs at any single point in the ring, there is still an alternate path for any device to communicate with every other device. As a result, the devices, systems and methods of the subject invention provide redundancy, which enables more reliable data transfer for various applications including a number of industrial control applications. In addition, utilizing the PCIe standard in this ring topology enables an extremely fast transfer of data from one device to another. Moreover, unlike conventional systems that utilize PCIe bus communication, the subject invention does not require a server or main host functioning as a PCIe root complex to control information from one device or node to the other, as each device can contact any other device on the ring.

One embodiment of the present invention is a system comprising a plurality of devices, each of the plurality of devices having a central processing unit connected to a Peripheral Component Interconnect Express (hereinafter PCIe) bridge. The devices are connected to each other in a peer-to-peer arrangement along high-speed communication connections in a ring. The PCIe bridge of each of the plurality of devices has at least one non-transparent (hereinafter NT) port. The PCIe bridge of each of the plurality of devices may have a first port and a second port for connecting respective devices to the ring. A third port may also be provided for transmitting and receiving data to and from the respective device to one or more of the plurality of devices in the ring. The system may be configured such that each of the devices are capable of transmitting and receiving data in two directions, left and right, around the ring.

A method of providing data transfer between an initiating device and a target device is also provided. In one embodiment, the method comprises the steps of providing a plurality of devices including an initiating device and a target device, each of the plurality of devices having a non-transparent PCIe bridge; connecting the plurality of devices in a peer-to-peer ring topology; and performing transfer of data by traversing the ring topology starting from the initiating device and ending at the target device. The PCIe bridge may include at least a first port, a second port, and a third port. The step of connecting the plurality of devices in the ring topology may include cabling the first and second ports of each of the devices to the ring topology using a high-speed communications connection, such as a PCIe cable or connector. In another embodiment, the method further comprises the step of connecting the third port to an internal PCIe bus within each of the plurality of devices, respectively.

In yet another embodiment, the method further comprises the step of selecting one of the first port and the second port on the initiating device from which to begin transfer of the data, based on a direction having the smallest number of intervening devices between the initiating device and the target device on the ring. In other words, data transfer may occur in a direction with the shortest distance to travel between the initiating and target device. In another embodiment, the method further comprises the step of reading or writing the data within an internal memory of the target device, after the ring topology has been traversed and transfer of data to and/or from the target device is completed. In another embodiment, the method further comprises the step of initiating transfer of data on the first port and the second port concurrently, in order to allow the transaction to proceed in both directions around the ring topology. In yet another embodiment, the method further comprises the step of initiating transfer of data from the initiating device to the target device in a first direction around the ring, and if a failure is detected, then initiating the transaction only in a second direction, opposite the failure, around the ring topology.

Other features and advantages of the disclosure will become apparent by reference to the following description taken in connection with the accompanying drawings.

### BRIEF DESCRIPTION OF THE DRAWINGS

Reference is now made briefly to the accompanying drawings, in which:

FIG. 1A is a diagram illustrating multiple compute devices connected in a ring topology according to the subject invention;

FIG. 1B is a diagram illustrating a break or failure in the connection between two compute devices connected together in the ring topology of FIG. 1A;

FIG. 2 is a diagram of an exemplary compute device according to the present invention, the device including a CPU connected to a PCIe bridge; the PCIe bridge having at least one NT port; and left and right connections connecting the compute device to the ring;

FIG. 3 is a block diagram illustrating the flow of data transfer from an initiating device to a target device starting at the non-transparent port of the initiating device, traversing the ring topology, and terminating at the local random access memory (hereinafter RAM) of the CPU of the target device (not shown);

FIG. 4 is a block diagram illustrating the address translation between compute devices connected in a ring topology according to the present invention;

FIG. 5 is a diagram showing the memory address translations between the respective PCIe bridges of compute devices connected in the ring topology of the present invention;

FIG. 6A is a table showing an example of the NT bridge memory windows seen by a given compute device's CPU in an exemplary system of the subject invention, in which there are five compute devices connected in a ring; and

FIG. 6B is a table showing an example of memory translations for one compute device in the exemplary system of FIG. 6A.

Like reference characters designate identical or corresponding components throughout the several views, which are not to scale unless otherwise indicated.

### DETAILED DESCRIPTION OF THE INVENTION

The devices, systems and methods of the subject invention are directed to a ring topology for connecting compute devices. The subject invention is particularly useful for applications where high bandwidth, low latency, redundancy, and ease of expansion are desired. The subject invention enables compute devices, each having a PCIe bridge with at least one NT port, to be networked in a ring topology. The subject invention overcomes the native topology of high-speed serial communication bus standards, like PCIe, in order to achieve a number of benefits and advantages over known apparatuses, systems and methods as described herein.

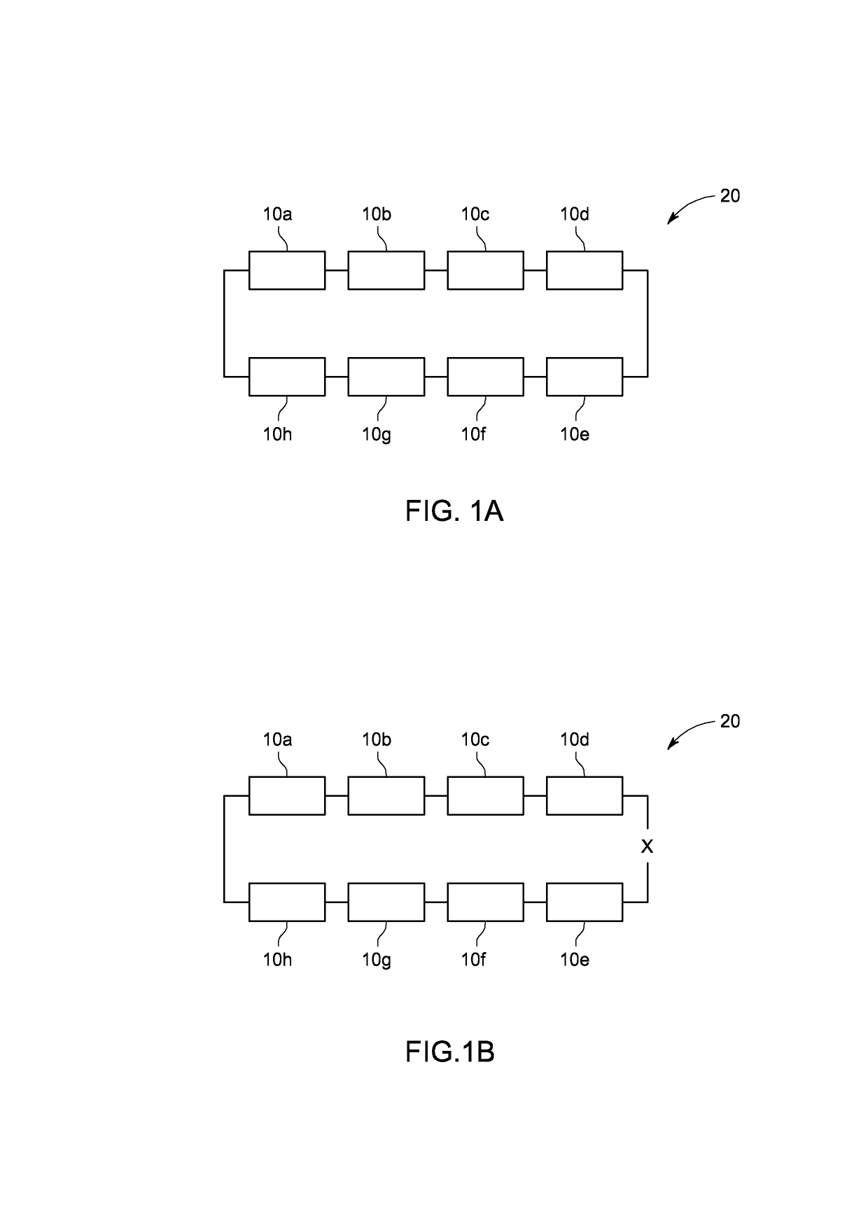

FIG. 1A is an exemplary block diagram of a system 20 according to the present invention having multiple compute devices connected in a ring topology. Two or more networked compute devices may be used to achieve the benefits of the subject invention. In this exemplary embodiment, there are eight compute devices 10a, 10b, 10c, 10d, 10e, 10f, 10g and 10h. Each of the compute devices 10a-10h has an internal PCIe port for connecting an internal PCIe bus of each of the compute devices to the ring. This allows access to the local compute device's RAM for memory transactions and allows the local CPU to initiate transactions. FIG. 1A illustrates compute devices 10a-10h connected to each other in a ring with no breaks or failures in the physical connection. Because of the ring topology, each compute device 10a-10h can communicate with every other compute device in a peer-to-peer relationship in one or two directions around the ring. In one embodiment, communication in two directions around the ring occurs simultaneously. Each of the compute devices 10a-10h has two physical connections or links connecting them to the ring, providing two paths to communicate with each of the other compute devices on the ring when no failure in the system 20 is present.

FIG. 1B illustrates a condition where a failure occurs in the system 20, and a loss in connectivity exists between one or more compute devices 10a-10h within the ring. A loss of connection is indicated by break “X” between compute devices 10d and 10e. However, in spite of the failure, the ring topology of the subject invention still allows for an alternate path for these compute devices 10d and 10e to communicate with each other and with every other compute device in the system 20. For example, because communication initiated from compute device 10d directly to compute device 10e by transmitting data to the right is inhibited, compute device 10d can alternatively transmit data by traversing the ring to the left and passing the information first through device 10c, then through device 10b, and so on, until it reaches the target device 10e. Accordingly, system 20 can be used in applications for redundancy purposes in order to provide increased reliability of data transfer between devices. Thus, the present invention achieves a significant advantage over known system where redundancy is implemented by providing two separate buses or duplicative modules connected to a single backplane requiring extra cost in both space and wiring.

In one embodiment, redundant transfer of data is achieved by sending a copy of the data from the initiating device simultaneously around both directions (left and right) of the ring to the target device(s) in the ring. In another embodiment, redundancy is achieved by initially transferring data only in one direction (left or right), and only after a failure is detected on that link would the other direction be used. With this method, a device could send data to any other device in the system 20 without active involvement from intervening devices in between the initiating device and the target device.

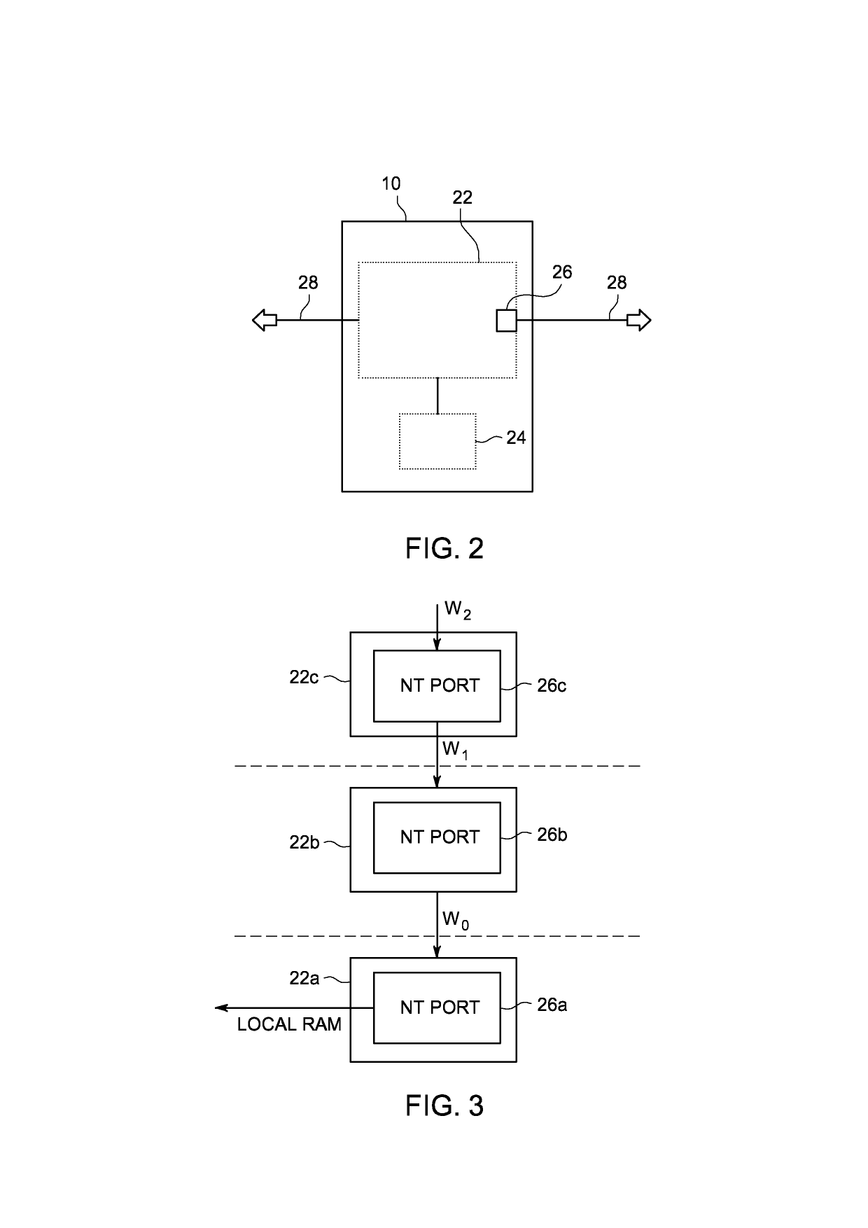

FIG. 2 is a block diagram of an exemplary device 10 according to the present invention. The device 10 has a CPU 24 connected to a bridge 22 with at least one non-transparent (NT) port 26. The left and right arrows represent the physical connections 28 connecting the device 10 to the ring and linking the device 10 with other compute devices in the network (not shown). In a preferred embodiment, the bridge 22 is a PCIe bridge, or switch, and the connection 28 is a PCIe cable or connector.

In another embodiment, there are multiple NT ports on each bridge of one or more of the compute devices in the ring topology. While one NT port is the minimal number to allow a PCIe ring topology, additional NT ports could be used as well. In addition, the NT port location could be reconfigured during system start-up to provide flexibility in the ring link connectors. For example, one or more of the compute devices could support both a cable connector and a stacking connector to directly plug into two compute devices. In yet another embodiment, one of the two ports on the PCIe bridge that connects the device to the ring could be either a proprietary connector for direct device-to-device links, or alternatively could be configured to be a PCIe cable connector for a link with cables.

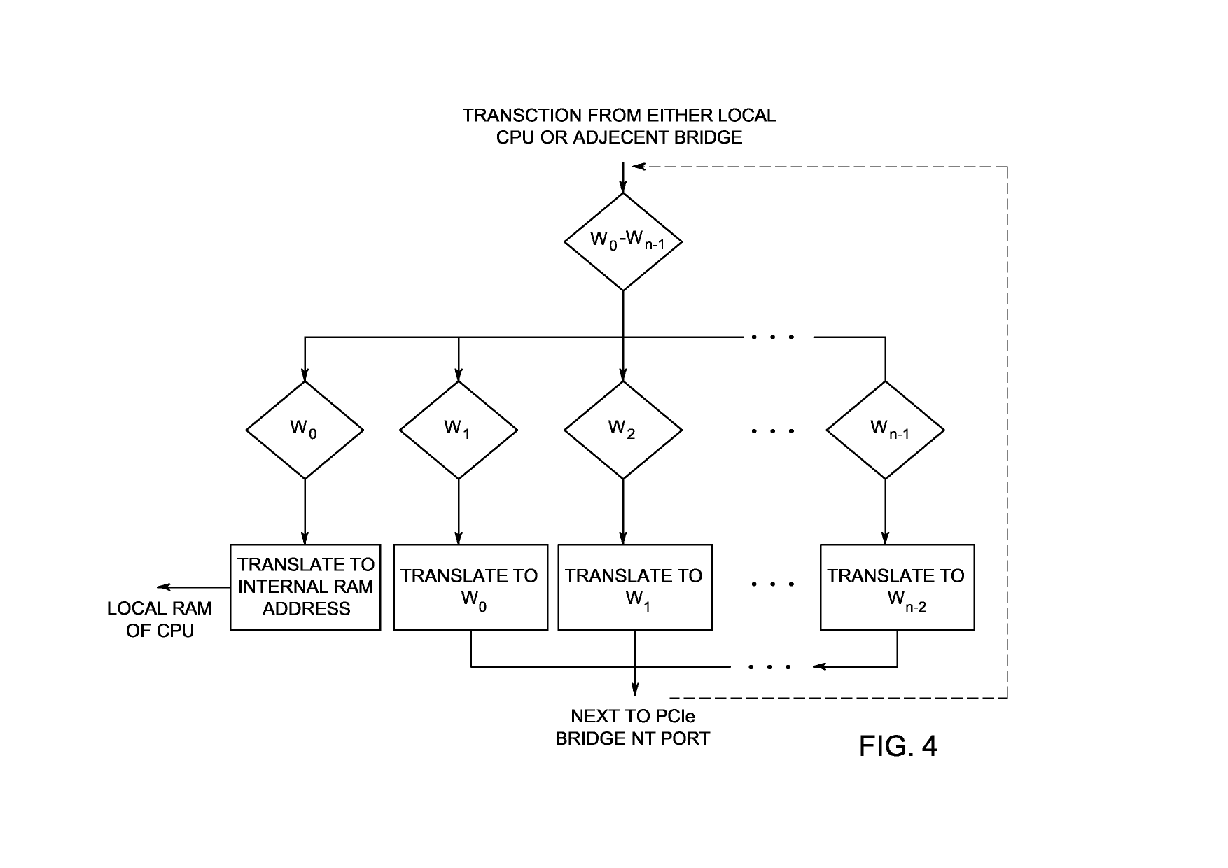

FIG. 3 is a block diagram illustrating an example of flow of data transfer from the initiating device 10c to a target device 10a. Devices 10a-10c are shown in FIG. 1A, however, only the bridge and ports of the respective devices are illustrated in FIG. 3. In this example, data flows from the NT bridge 26c present on the PCIe bridge 22c of the initiating device 10c, traverses the ring topology via the NT port 26b present on the PCIe bridge 22b of the intermediary device 10b, and terminates at the local RAM of the target device (not shown). Windows W₀, W₁, and W₂ represent the address window translations that occur as a transaction passes through each NT port. Each of NT ports 26c, 26b, and 26a implements the transaction flow illustrated in FIG. 4. FIG. 3 shows a transaction beginning with window W₂ and ending with window W₀ and a final translation to local RAM, but this could be extended for any transaction window Wₓ which results in x number of NT port translations to reach W₀ and then a final translation to local RAM.

FIG. 4 is a block diagram illustrating the address translation between devices connected in a ring topology according to the present invention. The NT port of each bridge accepts memory transactions for any of its configured memory windows (Wₙ₁ to W₀). Next, the specific window's address range is identified (e.g. W₁) and then the translation to another window occurs. The NT bridge translation is such that the window address range is decremented to the next lower windows range (i.e. Wₓ₋₁) and then passes the transaction with adjusted address window to the next bridge port. The exception is for transactions that enter the bridge for the W₀ address window, which are mapped to the device's local internal memory. When one device wishes to send data to another device in the ring, the CPU of the initiating device selects a CPU of a target device. The initiating CPU then determines which port (left or right) that it needs to interface with in order to reach the CPU of the target device. Assuming n devices in the ring, the initiating CPU then selects a memory Window [0 to n−1] and its corresponding memory address on the NT port for the desired target device. Finally, the initiating CPU begins a desired memory transaction, e.g. read or write data, to the CPU of the target device using the NT port memory address.

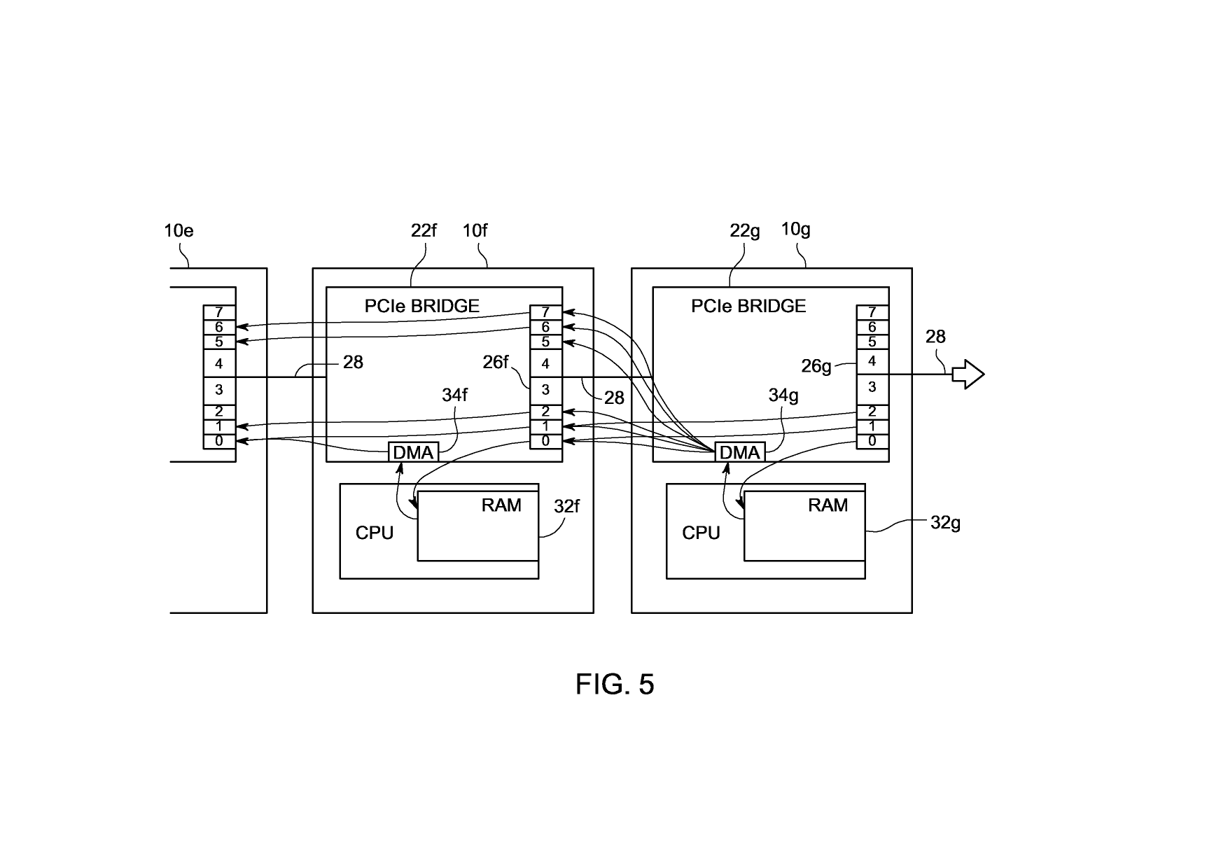

FIG. 5 is a diagram showing exemplary memory address translations between the respective PCIe bridges of three devices 10e-10g connected in the ring topology of the present invention. For example, suppose a ring supports 8 devices. Each bridge would need at least 8 memory windows in its NT port setup, as illustrated in FIG. 5. Each window is a relative location to a device on the ring. For example, device 10g has a PCIe bridge 22g having a NT port 26g with eight windows (Windows 0-7), and similarly device 10f has a PCIe bridge 22f having an NT port 26f with eight windows as well. Device 10e has the same seven window set up. Window 0 of device 10g is used to access the next adjacent device's memory, namely the RAM 32f of device 10f; Window 1 accesses device 10e, Windows 2 the device 10d (not shown), and so on. Assuming there are 8 devices 10a-10h on the ring and the ring is fully connected, then accessing Window 7 results in an access back to the same device 10g, in other words the PCIe transaction goes around the ring and back to itself. To support this relative addressing, the bridge window's address translations must be setup to shift the data window down by 1 for each hop through a ring bridge. For example, an access to Window 3 on the bridge must be translated to forward the transaction to Window 2 of the next bridge on the ring. Similarly Window 2 translates to Window 1, Window 1 to Window 0, and finally Window 0 maps to internal memory on the device. Window translations must be setup in both directions on the PCIe bridge to allow redundant or parallel transactions in either direction around the ring. RAM 32g and RAM 32f present on each device is the respective device's internal memory. RAM is the final destination of all transactions accessing a particular compute device on the ring (read or write of RAM). Direct Memory Access (hereinafter DMA) components, DMA 34g and DMA 32f are hardware components that may optionally be used by one or more compute devices to initiate transactions to another compute device in the ring. DMA can be programmed to transfer a set of data to or from a target device which allows the local device's CPU to concurrently perform other operations while DMA is in progress. The use of DMA improves performance especially for large data transfers.

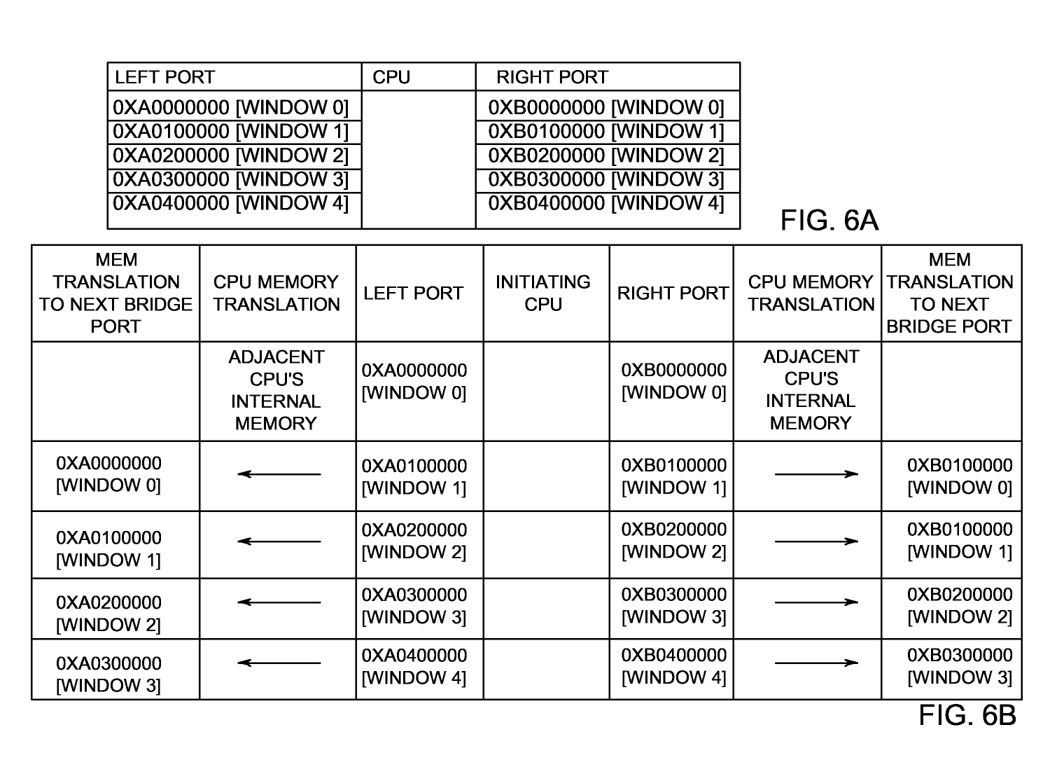

FIG. 6A is a table showing an example of memory windows on one embodiment of a PCIe bridge of a device 10 according to the subject invention. In this example, a PCIe bridge on each device is configured such that there are two NT ports, one on the left having an address base of 0xA0000000, and one on the right having an address base of 0xB0000000. In this exemplary embodiment, assume there are at most five target devices to each side of any CPU of any given device in the ring. Thus, there are a total of ten memory windows that can be seen by each CPU of each device, namely five memory windows in each direction around the ring. In the case of a single NT bridge port in each device, one set of windows is the translation provided by the NT bridge port of the adjacent device, as seen through the transparent port of its own PCIe bridge.

While there is only one NT port required per PCIe bridge, any communication to an adjacent device in the system will go through the NT port of that device. In one direction, the CPU of a given compute device interfaces with the NT port windows of its own PCIe bridge. In the other direction, the CPU interfaces with the NT port windows of the adjacent device. Both the left and right ports in this embodiment are NT ports so an address translation can be made for each window. The Window 0 port address translation will be mapped to the internal CPU's memory of the “adjacent” CPU in the ring. The exact memory address can be different for each CPU. The other Windows (1 to 4) must have a memory translation to the next device's NT port and move the memory address down by 1 memory window (for example, 0xA0100000 translates to 0xA0000000 into the next NT port).

FIG. 6B is a table showing an example of memory translations for one device's NT ports according to the present invention. Because each device's CPU implements the same address translations, any device's CPU in the ring can exchange data with any other device's CPU. Here are a few examples of how a given device's CPU is able to transfer data to reach a target device's CPU according to the present invention. Referring back to FIG. 1A, first consider the instance where an initiating device is device 10c and the target device is device 10d. The CPU of device 10c writes to 0xB0000000 which translates to internal memory of the CPU of device 10d. Second, consider the instance where the initiating device is device 10c and the target device is device 10e. In this case, the CPU of device 10c writes to 0xB0100000 which translates to 0xB0000000 within device 10d. Then, at the next NT port, 0xB0000000 translates to the internal memory of the CPU of device 10e. Third, consider an instance where device 10c initiates a data transfer to device 10g. Here, the CPU of device 10c writes to 0xA0300000 which translates to 0xA0200000 within device 10b. At the next NT port, 0xA0200000 translates to 0xA0100000 within device 10a. Then, at the next NT port, 0xA0100000 translates to 0xA0000000 within device 10h. And finally, at the next NT port, 0xA0000000 translates to the internal memory of the CPU of device 10g.

Devices in the ring topology of the subject invention may have heterogeneous operating systems. For example, in FIG. 1A, device 10a may have a Microsoft Windows based operating system, whereas device 10b may have a Vxworks or similar operating system, and so on. Irrespective of the operating system, each of the compute devices are adapted and configured to share information with each of the other compute devices connected in the ring topology in a peer-to-peer arrangement.

The devices, systems and methods of the subject invention described herein allow for higher reliability of data transfer on a network. The ring topology provides a mechanism to remove or repair a device without isolating or disrupting any communication to any other device in the ring. The ring topology also allows for a single point of failure such as a cable break without bringing down the entire network. In addition, if an additional device needs to be added to the network, a device will only need to be inserted between two existing devices and connected to the ring in the fashion described above with respect to existing devices. Although the connection between the two will be broken momentarily while the new node is added, the network traffic can be re-routed in the alternate path along the ring, so no communication is lost. Once the new device is added, it is automatically discovered by the other devices as traffic is passed through.

As used herein, an element or function recited in the singular and proceeded with the word “a” or “an” should be understood as not excluding plural said elements or functions, unless such exclusion is explicitly recited. Furthermore, references to “one embodiment” of the claimed invention should not be interpreted as excluding the existence of additional embodiments that also incorporate the recited features.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments. Other embodiments will occur to those skilled in the art and are within the scope of the following claims.

What is claimed is:

1. A system comprising:
a plurality of devices, each of the plurality of devices having a central processing unit connected to a PCIe bridge,
wherein the plurality of devices are connected to each other in a peer-to-peer arrangement along high-speed communication connections in a ring.

2. The system of claim 1, wherein each of the plurality of devices are capable of transmitting and receiving data in two directions around the ring.

3. The system of claim 1, wherein the PCIe bridge of each of the plurality of devices has at least one non-transparent port.

4. The system of claim 3, wherein the PCIe bridge of each of the plurality of devices has a first and second port for connecting its respective device to the ring, and a third port for transmitting and receiving data to and from the respective device to one or more of the plurality of devices in the ring.

5. A method of providing data transfer between an initiating device and a target device comprising the steps of
providing a plurality of devices including an initiating device and a target device, each of the plurality of devices having a non-transparent Peripheral Component Interconnect Express (PCIe) bridge;
connecting the plurality of devices in a peer-to-peer ring topology; and
performing transfer of data by traversing the ring topology starting from the initiating device and ending at the target device.

6. The method of claim 5, wherein the PCIe bridge comprises at least a first port, a second port, and a third port.

7. The method of claim 6, wherein the step of connecting the plurality of devices in the ring topology includes cabling the first and second ports of each of the devices to the ring topology using a high-speed connection.

8. The method of claim 7, wherein the high-speed connection is a PCIe connector.

9. The method of claim 7, further comprising the step of:
connecting the third port to an internal PCIe bus within each of the plurality of devices, respectively.

10. The method of claim 7, further comprising the step of:
selecting one of the first port and the second port on the initiating device from which to begin transfer of the data based on a direction having a smallest number of intervening devices between the initiating device and the target device on the ring.

11. The method of claim 10, further comprising the step of reading or writing the data within an internal memory of the target device, after the ring topology has been traversed and transfer of data to/from the target device is completed.

12. The method of claim 7, further comprising the step of:
initiating transfer of data on the first port and second port concurrently to allow the transaction to proceed in both directions around the ring topology.

13. The method of claim 5, further comprising the step of initiating transfer of data from the initiating device to the target device in a first direction around the ring, and if a failure is detected, then initiating the transaction only in a second direction around the ring topology.
